(19) United States
(12) Patent Application Publication
(10) Pub. No.: US 2008/0124019 A1
(43) Pub. Date: May 29, 2008

(54) MOLD STRUCTURE WITH FIBER-OPTIC SENSOR

(75) Inventors: YI-YONG ZHOU, Shenzhen (CN); TAO WEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/781,529

(22) Filed: Jul. 23, 2007

(30) Foreign Application Priority Data
Nov. 29, 2006 (CN) 200610157136.9

(51) Int. Cl. G02B 6/00

(52) U.S. Cl. 385/12

(57) ABSTRACT

A mold structure (100) includes a mold plate (402) and a fiber-optic sensor (30) mounted therein. The fiber-optic sensor may detect whether a metal insert has been put into the mold plate before the mold structure is closed. If the metal insert is already put in a desired position, the mold structure can be closed so as to avoid leaving out the metal insert. Therefore, the production and efficiency are greatly increased.

### BACKGROUND OF THE INVENTION

1. Field of the Invention

The present invention relates to mold structures and, particularly, to a mold structure with a fiber-optic sensor used in insert molding.

2. Description of related art

Insert molding is a process in which plastic is injected into a mold that contains an insert. The result of insert molding is a single molded plastic piece with an insert surrounded by the plastic. Inserts can be made of metal or different types of plastic. Insert molding is used in many industries. Applications for insert molding include the production of insert-molded couplings, threaded fasteners, filters, and electrical components. Insert molding expands the capabilities of plastic and can help reduce the cost of products by limiting the amount of costly metals needed to manufacture such products.

During a typical insert molding process, first a metal insert is put into a mold cavity of a mold. Then, the mold is closed so that molten material can be injected into the mold cavity, via a runner. The molten material in the cavity is cooled to form the molded product. However, if the metal insert is not put into the mold yet the mold is still closed, the mold could rather easily be destroyed. This situation not only affects manufacturing speed but also greatly reduces the work efficiency.

Therefore, a mold structure that can help prevent injection of molten material when no insert is present is desired in order to overcome the above-described shortcomings.

### SUMMARY OF THE INVENTION

One embodiment of a mold structure includes a mold plate and a fiber-optic sensor mounted therein. The fiber-optic sensor is configured (i.e., structured and arranged) for detecting whether a metal insert is put/placed into the mold plate before the mold structure is closed. If the metal insert is already placed in a desired position, the mold structure is permitted to close, so as to avoid leaving out the metal insert. Therefore, the production and efficiency are greatly increased.

Other advantages and novel features will become more apparent from the following detailed description when taken in conjunction with the accompanying drawings.

### BRIEF DESCRIPTION OF THE DRAWINGS

Many aspects of the present mold structure with a fiber-optic sensor can be better understood with reference to the following drawings. The components in the drawings are not necessarily drawn to scale, the emphasis instead being placed upon clearly illustrating the principles of the present mold structure with a fiber-optic sensor. Moreover, in the drawings, like reference numerals designate corresponding parts throughout the several views.

FIG. 1 is an exploded, isometric view of a present mold structure, according to one embodiment;

FIG. 2 is a schematic view of a fiber-optic sensor of FIG. 1;

FIG. 3 is an assembled view of the mold structure of FIG. 1; and

FIG. 4 is a cross-sectional view of the mold structure of FIG. 3.

### DETAILED DESCRIPTION OF THE EMBODIMENTS

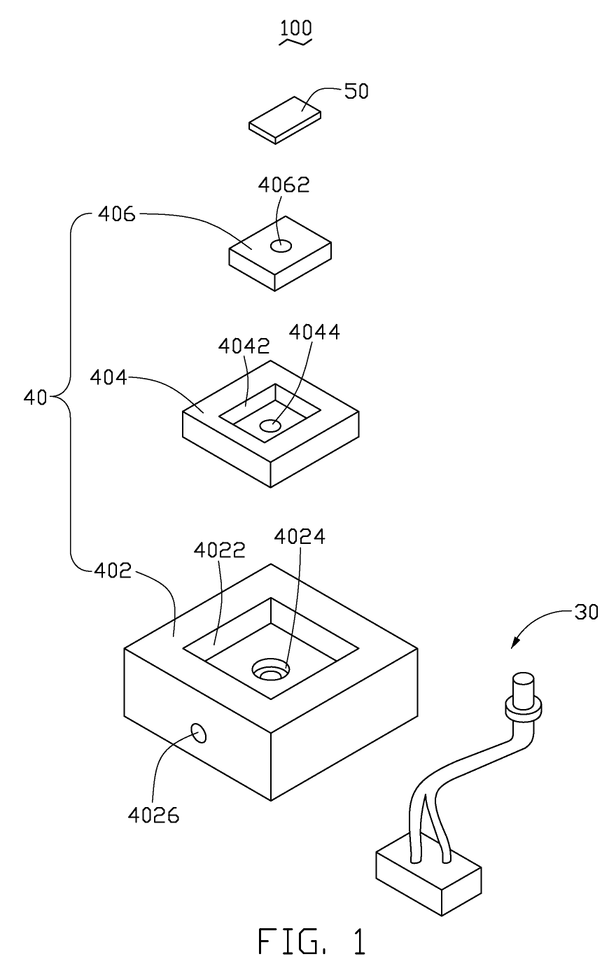

Referring now to the drawings in detail, FIG. 1 shows a mold structure 100, in accordance with a present embodiment. The mold structure 1 00 includes a movable mold plate 40 and a fiber-optic sensor 30. The fiber-optic sensor 30 may be fixed in the movable mold plate 40. A metal insert 50 is embedded in the mold structure 100.

The movable mold plate 40 includes a mold seat 402, a mold core 404, and a support element 406. The mold seat 402 is substantially cube-shaped or at least rectangular parallelepiped in shape and defines a rectangular cavity 4022 in a central area thereof. A stepped hole 4024 is defined in a bottom surface of the cavity 4022 (i.e., extends directly from such bottom surface further into the mold seat 402). A sidewall of the mold seat 402 defines a side hole 4026 therein. The side hole 4026 is a through-hole that communicates with the stepped hole 4024. The mold core 404 is usefully embedded in the mold cavity 4022 of the mold seat 402 and is beneficially fixed to the mold seat 402 by means of bolts. The mold core 404 defines a rectangular groove 4042 in a central area thereof. A bottom surface of the groove 4042 defines a core through hole 4044. An axis of the core through hole 4044 is aligned with that of the stepped hole 4024. The support element 406 is substantially rectangular and opportunely is embedded in the groove 4042. The support element 406 is thereby configured for supporting the metal insert 50. The support element 406 defines a central hole 4062 therein. An axis of the central hole 4062 is aligned with that of the core through hole 4044.

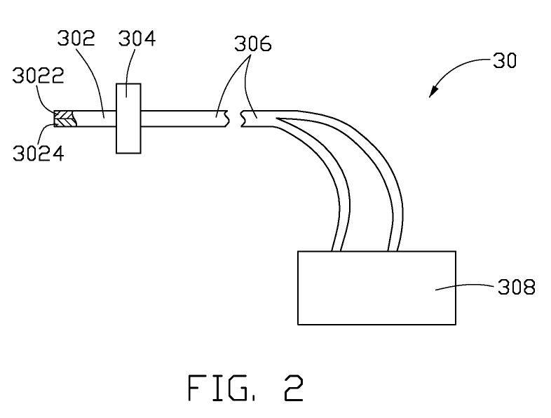

Referring to FIG. 2, the fiber-optic sensor 30 includes a fiber-optic head 302, a fixing portion 304, a sensor light conduit 306, and a fiber-optic amplifier 308. One end/face of the fixing portion 304 is connected to the fiber-optic head 302, and the opposite end/face of the fixing portion 304 is optically connected to a front/first end of the sensor light conduit 306 (i.e., in the form of an output (i.e., light-transmitting) fiber optic and an input (i.e., light-receiving) fiber optic). An opposite end of the sensor light conduit 306 is divided into two branches and is optically connected to the fiber-optic amplifier 308. The fiber-optic head 302 is cylindrical in shape and includes a light-emitting portion 3022 and a light-receiving portion 3024. The fixing portion 304 is substantially cylindrical in shape (i.e., disk-shaped). A diameter of the fixing portion 304 is significantly larger than those of the fiber-optic head 302 and the sensor light conduit 306. In particular, the diameter thereof is similar to that of the stepped hole 4024 of the movable mold plate 40, to permit a slide-fit therebetween and to thereby ensure that the fixing portion 304 is held in place during the molding procedure. As such, the fixing portion 304 is indeed able to fix the fiber-optic head 302 relative to the movable mold plate 40.

The light from the fiber-optic amplifier 308 may be transmitted to the light-emitting portion 3022 of the fiber-optic head 302 through the sensor light conduit 306. The sensor light conduit 306 is an optic channel (i.e., a fiber optic) configuring for transmitting light. The light-emitting portion 3022 is configured for transmitting/directing light onto the metal insert 50. Meanwhile, the light-receiving portion 3022 is configured for receiving the reflected light from the metal insert 50, and the reflected light is transmitted to the fiber-optic amplifier 308 though the sensor light conduit 306. The fiber-optic amplifier 308 is configured for detecting/measuring the strength of the reflected light so as to judge whether the metal insert 50 has been placed in the mold 1 00. It is to be understood that the junction between the sensor light conduit 306 and the fiber-optic head 302 at the fixing portion 304 could be either distinct or integral, for the purposes of the present mold sensor system.

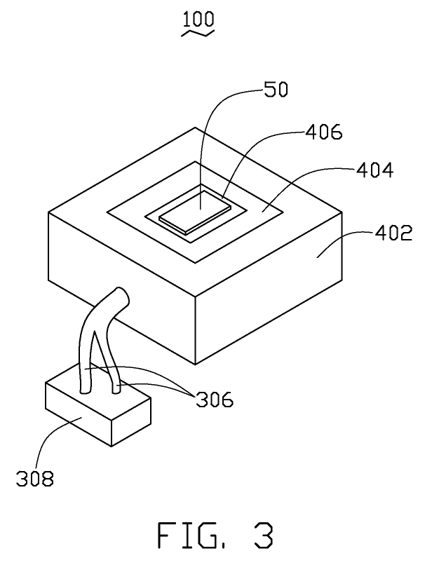

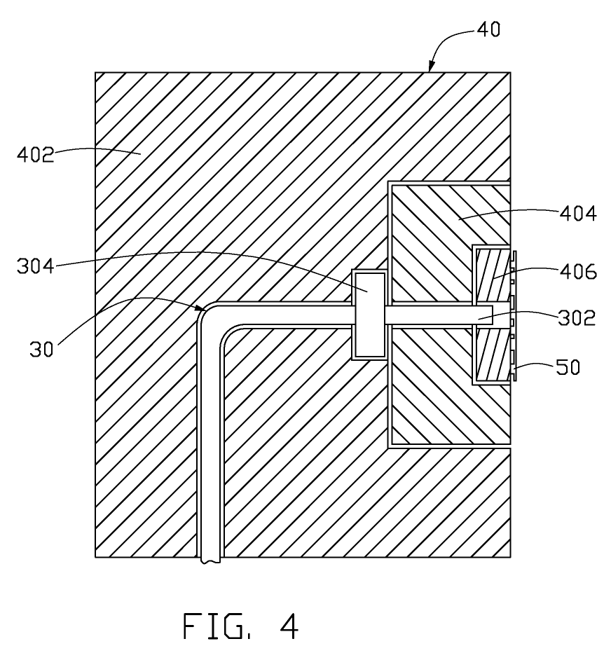

In assembly, referring to FIGS. 3 and 4, the fiber-optic sensor 30 is inserted into the stepped hole 4024 of the mold seat 402. The fixing portion 304 slidingly fits into and resists a stepped surface of the stepped hole 4024. The fiber-optic head 302 extends away from the mold cavity 4022 of the mold seat 402. At the same time, the sensor light conduit 306 extends in the opposite direction away the fixing portion 304 than does the fiber-optic head 302. The sensor light conduit 306 extends through the mold seat 402 and ultimately from the side hole 4026 thereof. The portion of the sensor light conduit 306 extending out of the side hole 4026 is connected to the fiber-optic amplifier 308. The fiber-optic amplifier 308 is connected to a control circuit of a molding machine.

In the opposite direction from the fixing portion 304, the fiber-optic head 302 passes through the through hole 4044 of the mold core 404, and the mold core 404 is fixed in the mold cavity 4022 of the mold seat 402 by means of, e.g., bolts. After that, the central hole 4062 of the support element 406 is placed around the fiber-optic head 302, and the support element 406 is received in the groove 4042 of the mold core 404. Finally, the metal insert 50 is fixed on the support element 406. Note that a top/distal end of the fiber-optic head 302 needs to be lower than a top surface of the support element 50, so as to avoid contact therebetween and thus avoid damage to that distal end.

In use, the fiber-optic amplifier 308 produces light. The light is transmitted to the fiber-optic head 302 by the sensor light conduit 306. Then, the light-emitting portion 3022 projects the light onto the metal insert 50. The light is reflected by the metal insert 50 to the light-receiving portion 3024. After that, the light-receiving portion 3024 again transmits light to the fiber-optic amplifier 308 through the sensor light conduit 306. Owing to the closeness/proximity of the metal insert 50 and the fiber-optic head 302 of the fiber-optic amplifier 30 and, potentially in part, to the generally reflective nature of metals, the light reflected by the metal insert 50 is stronger than any light reflected by an opposed mold portion (not shown). Likewise, if measured prior to moving another opposing mold portion into place, little or no reflection would be detected if the metal insert 50 were not in place. Therefore, the fiber-optic amplifier 308 may detect stronger light signals. If the strength of the light signal is more than a critical value of the output circuit of the fiber-optic amplifier 308 (i.e., indicating that the metal insert 50 is in place), the amplifier may output signals to the control circuit of the mold machine so as to instruct the mold to close. If the metal insert 50 is not put/placed on the support element 406, the fiber-optic head 302 will not receive enough reflected light and will not drive the mold machine to close.

A main advantage of the mold structure is that the mold structure may judge whether the metal insert is put into the mold so as to instruct the mold machine to close or not, thus avoiding damage to the mold structure. Accordingly, the production and efficiency are greatly increased. Likewise, a reduction in long-term equipment expenditures (i.e., in terms of maintenance and/or replacement costs) can be expected.

Understandably, the fiber sensor may be applied in other types of molds, such as pressing molds. The fiber-optic sensor also may be assembled into a fixed mold plate so as to detect the metal insert.

In still further alternative embodiments, the number of the fiber-optic sensors may be two or more. Further, for example, if three or more fiber-optic sensors are employed, the fiber-optic sensors could be used not only to detect whether the metal insert is put into the mold but also may judge whether the metal insert is inserted flush to the sensor and/or the mold base.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A mold structure comprising:
a mold plate; and
a fiber-optic sensor fixed in the mold plate, the fiber-optic sensor being configured for detecting whether a metal insert is placed into the mold plate before the mold structure is closed.

2. The mold structure as claimed in claim 1, wherein the mold plate is a movable mold plate.

3. The mold structure as claimed in claim 1, wherein the fiber-optic sensor includes a fiber-optic head, a fixing portion, a sensor light conduit, and a fiber-optic amplifier, one face of the fixing portion being connected to the fiber-optic head, another opposing face of the fixing portion being connected to a front end of the sensor light conduit.

4. The mold structure as claimed in claim 3, wherein one end portion of the sensor light conduit opposite the front end thereof is divided into two branches, the two branches connecting with the fiber-optic amplifier.

5. The mold structure as claimed in claim 3, wherein the fiber-optic head includes a light-emitting portion and a light-receiving portion.

6. The mold structure as claimed in claim 1, wherein the mold plate includes a mold seat, a mold core, and a support element, the mold seat receives the mold core, and the support element is embedded in the mold core.

7. The mold structure as claimed in claim 6, wherein the mold seat defines a mold cavity in a central area thereof, a stepped hole is defined in a bottom surface of the mold cavity, a sidewall of the mold seat defines a side hole, and the side hole communicates with the stepped hole.

8. The mold structure as claimed in claim 7, wherein the fiber-optic sensor includes a fiber-optic head, a fixing portion, a sensor light conduit, and a fiber-optic amplifier, and the sensor light conduit passes through the side hole and is connected to the fiber-optic amplifier.

9. A mold structure for a mold machine, the mold structure needing to put a metal insert therein, comprising:
a mold seat;
a mold core being received in the mold seat;
a support element being embedded in the mold core; and
a fiber-optic sensor passing through the mold seat, the mold core, and the support element, the fiber-optic sensor facing the metal insert and having a light-transmitting portion and a light-receiving portion, the light-transmitting portion of the fiber-optic sensor being configured for providing light capable of illuminating the metal insert in the presence thereof, the light-receiving portion of the fiber-optic sensor being configured for receiving and thereby sensing reflected light, the fiber-optic sensor being configured for judging a strength of the reflected light in order to determine whether to drive the mold machine to close or not.

10. The mold structure as claimed in claim 9, wherein the fiber-optic sensor includes a fiber-optic head, a fixing portion, a sensor light conduit, and a fiber-optic amplifier, one side of the fixing portion is connected to the fiber-optic head, and an opposite side of the fixing portion is connected to a front end of the sensor light conduit.

11. The mold structure as claimed in claim 10, wherein an end of the sensor light conduit opposite to the front end thereof is divided into two branches, the two branches connecting with the fiber-optic amplifier.
